(19) United States
(12) Patent Application Publication
(10) Pub. No.: US 2009/0164209 A1
(43) Pub. Date: Jun. 25, 2009

(54) DEVICE AND METHOD FOR CAPTURING AND FORWARDING VERBALIZED COMMENTS TO A REMOTE LOCATION

(76) Inventors: Brian ERICKSON, Hamilton, VA (US); Nicole ERICKSON, Hamilton, VA (US)

Correspondence Address: Gregory Stephens;Williams Mullen PC, P.O. Box 13646, Research Triangle Park, NC, 27709-3646, US

(21) Appl. No.: 11/959,613

(22) Filed: Dec. 19, 2007

(51) Int. Cl. G10L 19/00; G06F 15/16

(52) U.S. Cl. 704/201; 709/206

(57) ABSTRACT

Disclosed is a device for sending a verbalized comment to a remote computer server. The device includes a processor that executes and operates the various software and hardware components. A microphone is utilized to record a comment. Temporary storage buffers the recorded comment. An auto-dialing application is utilized to automatically dial a telephone number associated with the remote computer server. The mode of transmission can include an RF module for automatically establishing a voice connection with an external mobile network, a WiFi module for automatically establishing a voice connection with an external IP network, and a plain old telephone service (POTS) interface module for automatically establishing a voice connection with an external legacy telephone network. The comment can be sent via email over an IP network, via MMS over a mobile network, or directly over a telephone connection including POTS, cellular (mobile), and VoIP.

### SUMMARY OF THE EMBODIMENTS OF THE INVENTION

In one embodiment, there is disclosed a system and method for sending a verbalized comment from a device situated at or near a point-of-sale or a point-of-service to a remote computer server. The method includes receiving audio input at the device, storing the received audio in a temporary buffer, and automatically forwarding the audio input to the remote computer server. Forwarding the audio input to the remote computer server entails automatically establishing a telephone voice connection with the remote computer server using one of a plain old telephone service (POTS) network, a mobile cellular network, and a voice over Internet Protocol (VoIP) network. The recorded audio can be played back over the established telephone connection. Or, the recorded audio can be inserted as an audio file attachment into an email or multi-media message service (MMS) message and sent over the appropriate network to the remote computer server.

In another embodiment, there is disclosed a system and method for sending a text data comment from a device situated at or near a point-of-sale or a point-of-service to a remote computer server. The method includes receiving text data input at the device, storing the received text data in a temporary buffer, and automatically forwarding the text data comment to the remote computer server. Forwarding the text data comment to the remote computer server can entail automatically composing an email message addressed to the remote computer server and including the text data comment either directly within the body of the email message or as a text file attachment. The text data comment may also be appended to an automatically composed MMS message and sent to the remote computer server.

### BRIEF DESCRIPTION OF THE DRAWINGS

FIG. 1 is an illustration of a device according to an example embodiment of the present invention.

FIG. 2 is an illustration of various components that comprise an embodiment of the present invention.

FIG. 3 is an illustration of a device operable within several exemplary network architectures according to example embodiments of the present invention.

FIG. 4 is a flowchart pertaining to capturing and forwarding a verbalized comment according to an embodiment of the present invention.

FIG. 5 is a flowchart pertaining to capturing and forwarding a text comment according to an embodiment of the present invention.

### DETAILED DESCRIPTION OF THE INVENTION

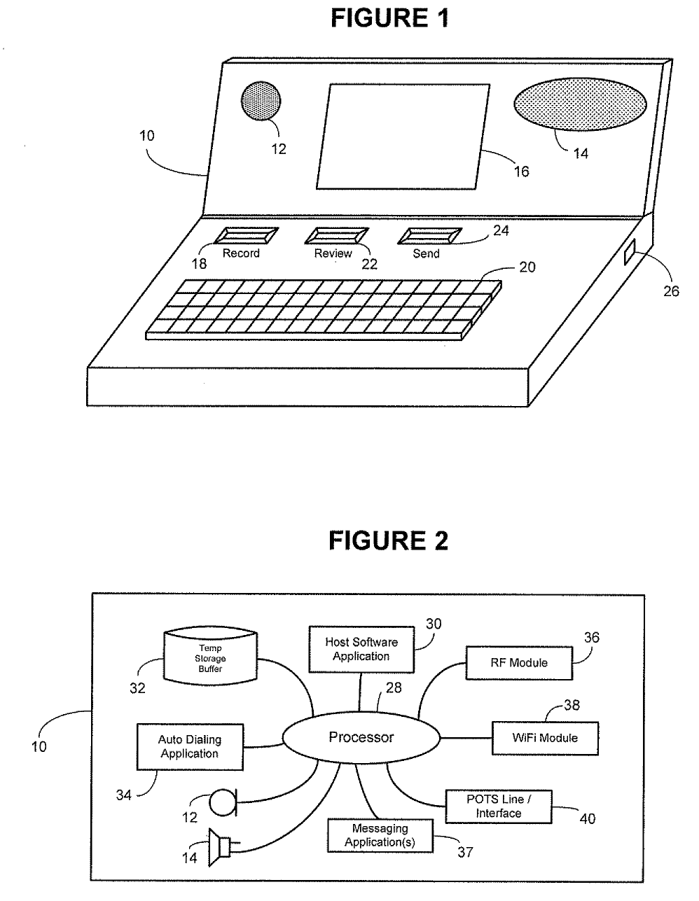

FIG. 1 is an illustration of a communications device 10 according to an example embodiment of the present invention. The communications device 10 can stand alone at a point-of-sale or point-of-service to provide instant verbal and/or textual feedback to the service provider or merchant. The merchant can collect this data from multiple communications devices 10 that are geographically dispersed over a large area to create a customer feedback database of comments that can be used to evaluate the goods and/or services that are provided. It can also serve as an “electronic suggestion box” in which verbal and/or textual comments can be sent to a remote location for further evaluation.

The communications device 10 may include one or more modes of input and output to assist a customer in composing a comment. For verbalized comments, a microphone 12 is incorporated into the housing of the communications device 10. The microphone can be actuated upon depression of a record button 18 such that the customer's verbalized comment is captured in a temporary storage buffer. The customer can be given the opportunity to review his comment by depressing a review button 22 which causes the recorded comment to be played back over a speaker 14. Once the customer is satisfied with his comment, he can depress a send key 24 to cause the verbalized comment to be sent to a remote location where it is stored for later analysis by the service provider/merchant.

For textual comments, a standard QWERTY type keyboard 20 can be included with the communications device 10 along with a display 16. The customer can type his comment using the keyboard 20 and review it on the display 16. When satisfied, the user can depress the send key 24 to cause the text to be sent to a remote location where it is stored for later analysis by the service provider/merchant.

One or more jacks 26 (e.g., POTS, Ethernet, USB, etc,) can be included to provide a wired connection to one or more voice or data networks that are ultimately linked with a computer database server at a remote location that is designed to receive the comments.

FIG. 2 is an illustration of some of the internal components of a communications device 10 in accordance with embodiments of the present invention. Within the communications device 10 there are included several components that operate to practice the embodiments of the invention. Not all the components that comprise a communications device 10 are illustrated, however.

A processor 28 serves to coordinate and control the operations and interactions among the various components. A host software application 30 working in conjunction with the processor 28 and other components provides user interface functionality, voice recording and playback functionality via microphone 12 and speaker 14 respectively, access to a temporary storage buffer 32, an interface to an auto-dialing application 34, an interface to one or more messaging applications 37, as well as interfaces to a cellular RF module 36, a WiFi module 38, and a plain old telephone service (POTS) module 40.

The temporary storage buffer 32 stores voice recorded and/or text entered comments from customers. Once the customer has sent the comment to the remote location, the temporary storage buffer 32 can overwrite the data with new data.

The auto-dialing application 34 is programmed to automatically dial a specific telephone number that is associated with a computer database server at a remote location. Once a connection is established, the host software application 30 will cause the currently stored comment to be sent/played so that it can be recorded by the computer database server at the remote location.

The messaging application(s) 37 can be utilized to automatically pack an email message or a multi-media messaging service (MMS) message with a audio file or text file created by a customer. The message can then be automatically sent over the appropriate interface and network to the computer database server at the remote location.

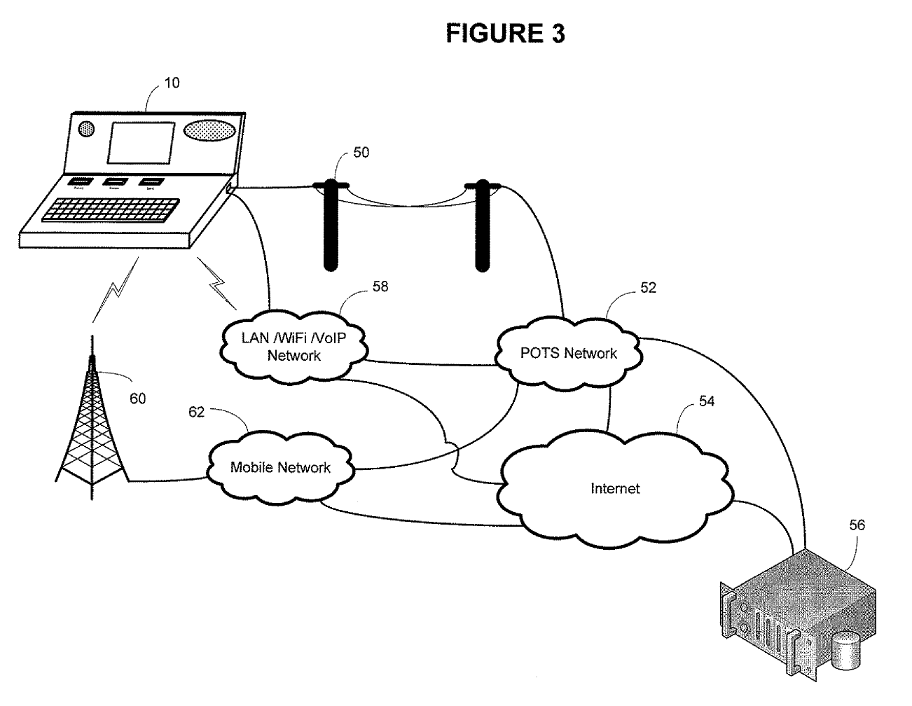

FIG. 3 is an illustration of a device operable within several exemplary network architectures according to example embodiments of the present invention. There are a variety of data formats and transmission paths that can be utilized by the communications device 10 to send a comment (audio or text) to a computer database server 56 at the remote location. These include, but are not necessarily limited to, a mobile cellular connection, an Internet protocol packet based network connection, and a plain old telephone service (POTS) connection.

If using a POTS transmission path, the communications device 10 is interfaced to the POTS network 52 by way of traditional telephone wiring 50. Recorded audio can be sent by having the auto-dialing application 34 initiate a telephone call to a telephone number associated with the computer database server 56 at the remote location. Once the call is connected, the host software application 30 will cause playback of the customer recorded verbalized comment over the telephone connection 50 that is coupled with the POTS network 52 connection. The POTS network 52 can be coupled with the computer database server 56 at the remote location where it can be recorded and stored.

If using a an Internet protocol packet based network transmission path, comments in audio or text format can be sent to the computer database server 56 at the remote location. In addition, audio can be sent either using a Voice Over IP (VoIP) telephony protocol similar to using a standard telephone. The auto-dialing application 34 initiates a telephone call to a telephone number associated with the computer database server 56 at the remote location. Once the call is connected, the host software application 30 will cause playback of the customer recorded verbalized comment over a local network 58 that is coupled with the POTS network 52 connection. The POTS network 52 can be coupled with the computer database server 56 at the remote location where it can be recorded and stored.

Or, the IP network can be used in conjunction with a messaging application 37 such as email. The recorded audio can be formatted into a desired audio file format and attached in an email addressed to a mailbox associated with the computer database server 56 at the remote location. The messaging application 37 could utilize a WiFi module 38 or a standard Ethernet cabled connection to forward the comment via a local network 58 to the Internet 54 into the computer database server 56 at the remote location. This transmission path would also work for text based comments that could be contained in a text attachment or the body of an email message.

If using a mobile cellular transmission path, a recorded comment can be sent utilizing the auto-dialing 34 to initiate a telephone call to a telephone number associated with the computer database server 56 at the remote location. Once the call is connected, the host software application 30 will cause playback of the customer recorded verbalized comment using the RF module 36 to the Mobile tower 60 and mobile network 62. The mobile network 62 can be coupled with either the POTS network 52 or the Internet 54. The POTS network 52 and/or the Internet 54 can be coupled with the computer database server 56 at the remote location where it can be recorded and stored.

The communications device 10 may also utilize the RF module 36 and mobile network 62 along with the messaging application 37 to compose and send an MMS message with either a text or audio attachment. The MMS message can be addressed to the computer database server 56 at the remote location.

There are several audio formats that could be used in conjunction with the procedures described herein. The exact audio file format is not necessarily considered as definitive of the embodiments of the invention as more than one audio file format may be implemented including, but not limited to, MP3, WAV, MIDI, ATRAC, RM, WMA, PCA, OGG.

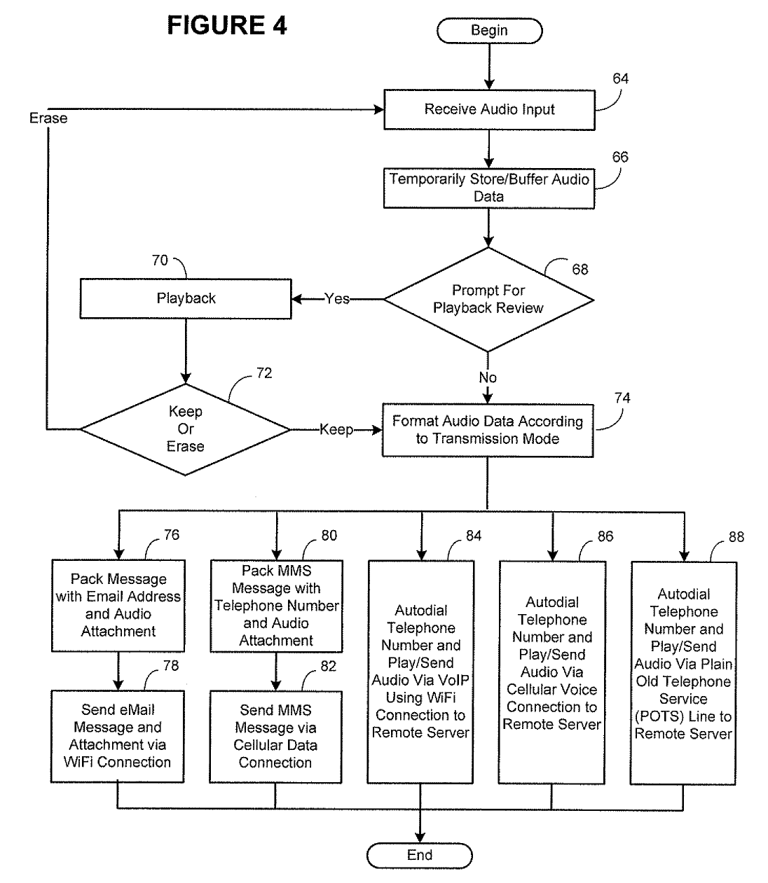

FIG. 4 is a flowchart pertaining to capturing and forwarding a verbalized comment according to an embodiment of the present invention. The process begins when a user initiates a recording function and audio input is received 64 via a microphone. The received audio data is temporarily stored or buffered 66. The system then prompts the user (or the user can self initiate) whether a playback review 68 to hear how the comment was recorded is desired. If the user desires a playback review, the just recorded audio is played back 70 over a speaker. The user can then opt to keep or erase the recorded comment 72. If the user opts to erase the comment, it is erased and control is returned to the “receive audio input” block 64 to start again. Otherwise, the audio data is formatted according to the transmission mode 74 that will be used to send the audio comment to the remote server.

There are several transmission modes available to the system. One such mode provides for automatically sending the recorded audio comment as an audio attachment to an email message. In this mode, the system will automatically compose an email message with a destination address corresponding to the remote computer server. The email message is then packed with the audio attachment 76 and sent 78 to the remote computer server via a WiFi connection or a wired Ethernet connection.

Another transmission mode provides for automatically sending the recorded audio comment as an audio attachment to a multi-media service (MMS) message over a cellular data connection. In this mode, the system will automatically compose an MMS message with a destination telephone number corresponding to the remote computer server. The MMS message is then packed with the audio attachment 80 and sent 82 to the remote computer server via an RF module to a mobile network.

Still another transmission mode provides for automatically sending the recorded audio comment as live audio over a VoIP connection. In this mode, the system will automatically dial a destination telephone number corresponding to the remote computer server using a VoIP application. The audio is then played back over the established VoIP connection 84 where it can be recorded by the remote computer server. The VoIP connection can utilize either a WiFi connection to an IP network or an Ethernet cabled connection to an IP network.

Yet another transmission mode provides for automatically sending the recorded audio comment as live audio over a cellular connection. In this mode, the system will automatically dial a destination telephone number corresponding to the remote computer serve using an RF module and mobile network infrastructure. The audio is then played back over the established mobile (cellular) connection 86 where it can be recorded by the remote computer server.

Yet another transmission mode provides for automatically sending the recorded audio comment as live audio over a plain old telephone service (POTS) connection. In this mode, the system will automatically dial a destination telephone number corresponding to the remote computer serve using ordinary telephone hard-wired legacy network infrastructure. The audio is then played back over the established telephone line connection 88 where it can be recorded by the remote computer server.

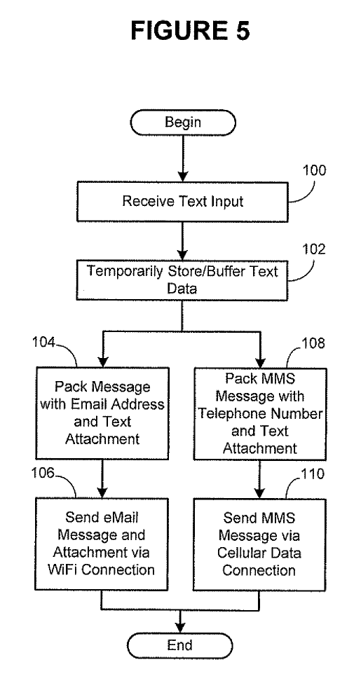

FIG. 5 is a flowchart pertaining to capturing and forwarding a text comment according to an embodiment of the present invention. In this embodiment, a user can type text into the device 100 as opposed to recording a verbal comment. The text is stored in a temporary buffer 102. The text comment can then be automatically forwarded to a remote computer server either as a part of an email message 104 or as part of an MMS message 108. If sent as an email, an application in the device will automatically compose an email and send 106 it to the remote computer server using the input text as the body of the email message. If sent as an MMS message, an application in the device will automatically compose an MMS message and send 106 it to the remote computer server using the input text as an attachment to the MMS message.

The description has illustrated examples and embodiments in which a recorded or typed comment was immediately forwarded to the remote computer server upon its creation and approval. The approved comments can be stored locally within the device and pushed out as a batch at pre-determined intervals as well. Thus, a single device can obtain “comments” all day and upload them to the remote server every night at say, 2:00 AM, for instance.

As will be appreciated by one of skill in the art, the present invention may be embodied as a method or system. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the mobile communications device or the like. Prompts may also be audible, vibrating, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. If will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof,

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method of sending a verbalized comment from a device situated at or near a point-of-sale or a point-of-service to a remote computer server, the method comprising:
receiving audio input at the device;
storing the received audio in a temporary buffer; and
automatically forwarding the audio input to the remote computer server.

2. The method of claim 1 wherein forwarding the audio input to the remote computer server comprises:
automatically establishing a telephone voice connection with the remote computer server using a plain old telephone service (POTS) network; and
automatically playing the recorded audio back over the established telephone connection.

3. The method of claim 2 wherein establishing a telephone voice connection with the remote computer server using a plain old telephone service (POTS) network comprises having an auto-dialing device automatically dial the telephone number associated with the remote computer server.

4. The method of claim 1 wherein forwarding the audio input to the remote computer server comprises:
automatically establishing a telephone voice connection with the remote computer server using a mobile cellular network; and
automatically playing the recorded audio back over the established telephone voice connection.

5. The method of claim 4 wherein establishing a telephone voice connection with the remote computer server using a mobile cellular network comprises having an auto-dialing device automatically dial the telephone number associated with the remote computer server.

6. The method of claim 1 wherein forwarding the audio input to the remote computer server comprises:
automatically establishing a telephone voice connection with the remote computer server using a voice over Internet Protocol (VoIP) network; and
automatically playing the recorded audio back over the established telephone voice connection.

7. The method of claim 6 wherein establishing a telephone voice connection with the remote computer server using a voice over Internet Protocol (VoIP) network comprises having an auto-dialing device automatically dial the telephone number associated with the remote computer server.

8. The method of claim 1 wherein forwarding the audio input to the remote computer server comprises:
automatically composing an email message having a destination address associated with the remote computer server;
attaching the recorded audio as a file attachment to the email message; and
automatically sending the email message from the device to the remote computer server over an IP network.

9. The method of claim 1 wherein forwarding the audio input to the remote computer server comprises:
automatically composing a multi-media service (MMS) message having a destination telephone number associated with the remote computer server;
attaching the recorded audio as a file attachment to the MMS message; and
automatically sending the MMS message from the device to the remote computer server over a cellular mobile network.

10. The method of claim 1 further comprising reviewing the recorded audio prior to forwarding the audio input to the remote computer server such that it can be erased if desired.

11. A method of sending a text comment from a device situated at or near a point-of-sale or a point-of-service to a remote computer server, the method comprising:
receiving text data at the device;
storing the received text data in a temporary buffer; and
automatically forwarding the text data to the remote computer server.

12. The method of claim 11 wherein forwarding the text data to the remote computer server comprises:
automatically composing an email message having a destination address associated with the remote computer server;
attaching the text data as a file attachment to the email message; and
automatically sending the email message from the device to the remote computer server over an IP network.

13. The method of claim 11 wherein forwarding the text data to the remote computer server comprises:
automatically composing an email message having a destination address associated with the remote computer server;
inserting the text data into the body of the email message; and
automatically sending the email message from the device to the remote computer server over an IP network.

14. The method of claim 11 wherein forwarding the text data to the remote computer server comprises:
automatically composing a multi-media service (MMS) message having a destination telephone number associated with the remote computer server;
attaching the text data as a file attachment to the MMS message; and
automatically sending the MMS message from the device to the remote computer server over a cellular mobile network.

15. A device for sending a verbalized comment to a remote computer server comprising:
a processor for executing and operating the various software and hardware components of the device;
a microphone coupled with the processor for recording a verbalized comment;
temporary storage coupled with the processor for buffering the recorded verbalized comment;
an auto-dialing application coupled with the processor for dialing a telephone number associated with the remote computer server;
one or more of:
an RF module coupled with the processor for automatically establishing a voice connection with an external mobile network;
a WiFi module coupled with the processor for automatically establishing a voice connection with an external IP network; and
a plain old telephone service (POTS) interface module coupled with the processor for automatically establishing a voice connection with an external legacy telephone network; and
one or more of:
an email application coupled with the processor for automatically composing and sending an email message including an audio file attachment to an email address associated with the remote computer server; and
a multi-media service (MMS) application coupled with the processor for automatically composing and sending an MMS message including an audio file attachment to a telephone number associated with the remote computer server.

16. The device of claim 19 further comprising a speaker coupled with the processor for playing back the recorded verbalized comment.

17. A device for sending a text comment to a remote computer server comprising:
a processor for executing and operating the various software and hardware components of the device;
a keyboard coupled with the processor for accepting a text data comment;
a display for displaying the text data comment as it is being composed;
temporary storage coupled with the processor for buffering the text data comment;
one or more of:
an RF module coupled with the processor for automatically establishing a data connection with an external mobile network; and
a WiFi module coupled with the processor for automatically establishing a data connection with an external IP network; and
one or more of:
an email application coupled with the processor for automatically composing and sending an email message including a text file attachment to an email address associated with the remote computer server; and
a multi-media service (MMS) application coupled with the processor for automatically composing and sending an MMS message including a text file attachment to a telephone number associated with the remote computer server.
